(19) United States
(12) Patent Application Publication
(10) Pub. No.: US 2007/0274187 A1
(43) Pub. Date: Nov. 29, 2007

(54) Method and system for chapter marker and title boundary insertion in dv video

(75) Inventors: Alphonsus Tarcisius Jozef Maria Schipper, Eindhoven (NL); Zoran Stankovic, Eindhoven (NL); Michal Czarkowski, Elk (PL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/580,495

(22) PCT Filed: Nov. 15, 2004
(86) PCT No.: PCT/IB04/52422

§ 371 Date: May 23, 2006

(30) Foreign Application Priority Data
Nov. 27, 2003 (EP) 03104427.4

(51) Int. Cl. G11B 3/64

(52) U.S. Cl. 369/85

(57) ABSTRACT

Method and recording system for obtaining a data recording on a first medium, such as a DVD, from a data stream originating from a second medium, such as a DV tape. The data stream comprises a number of data segments each having a different recording start time. In the present invention, which may be used ‘on the fly’ and in combination with a pre scan, a recording segment of the data recording on the first medium is generated based on a determination of a duration of a present recording segment. A new recording segment is generated when a recording time discontinuity exceeds a threshold value, the recording time discontinuity being a difference between a recording end time of a first data segment and a recording start time of a next data segment.

### TECHNICAL FIELD

The present invention relates to a method for obtaining a data recording, such as a (digital) video recording, on a first medium, such as a DVD, from a data stream originating from a second medium, such as a digital video tape, the data stream comprising a plurality of data segments or scenes each having a different recording start time. The method comprises generating a recording segment of the data recording on the first medium based on a determination of a duration of a present recording segment.

In a further aspect, the present invention relates to a recording system for obtaining a data recording on a first medium from a data stream originating from a second medium, the data stream comprising a plurality of data segments each having a different recording start time, the recording system comprising input means for receiving the data stream from the second medium, output means for storing the data recording on the first medium, and processing means connected to the input means and output means, which processing means are arranged for generating a recording segment of the data recording on the first medium based on a determination of a duration of a present recording segment.

### BACKGROUND ART

American patent application US2002/0168181 describes a method and device for digital video capture. A video recording is split into several files, based on a set of criteria. The criteria comprise a detection of a change in a video scene and the time duration of a video recording. When the video scene changes, as detected by image processing techniques, it is assumed that a new scene (a different event) starts, and consequently a new file is generated. Alternatively, when a scene takes too long, and no scene change is detected, a new file is also initiated. This method and device have the disadvantage that every scene change will lead to the generation of a new file, which may lead to a very large number of separate files originating from a single recording.

### SUMMARY OF THE INVENTION

The present invention seeks to provide an improved indexing method and system, in particular suited for the recording of video data.

According to a first aspect of the present invention, a method according to the preamble defined above is provided, in which a new recording segment is generated when a recording time discontinuity exceeds a threshold value, the recording time discontinuity being a difference between a recording end time of a first data segment and a recording start time of a next data segment. By only starting a new data segment when the recording time discontinuity exceeds a threshold value it is possible to provide an efficient index marker insertion in a data recording, and too large a number of index marker insertions is prevented. In digital video, index markers such as chapter markers are used to indicate the start of a new data segment.

The present invention may be implemented in two manners, ‘on the fly’ and ‘pre-scan’. When using the present invention in the ‘on the fly’ embodiment, it is unknown what data is still to be recorded (time of recording, number of scene changes, etc.). In a further embodiment, using the ‘on the fly’ alternative, the threshold value is a function dependent on a desired recording segment duration and the present recording segment duration. By properly selecting the threshold value function, in which the threshold value is a predefined function in time, it is possible to prevent too large a number of index marker insertions, even when the properties of the data to be recorded is unknown (‘on the fly’).

In an embodiment of the present method, the new recording segment is generated by insertion of index markers of a first type in the data recording on the first medium. In digital video recording applications, the index markers of the first type are called chapter markers. Adding index markers is a simple operation in digital video processing, which does not require many resources in the data processing.

In a further embodiment the threshold value function is a continuously decreasing function in time. This can be a linear, quadratic, exponential or other type of decreasing function. This allows to lower the threshold value when a current data segment length increases, thus steering the insertion of an index marker in a position which is a logical position in view of the original scenes, while at the same time obtaining data segments of globally the same length.

As an exemplary embodiment, the threshold function comprises a combination of two linear functions in time:
th(t)=tho−a1*(t−C*d) for t<(C+0.5)*d;
th(t)=th1−a2*(t−(C+1)*d) for (C+0.5)*d<t<(C+1.5)*d;
th(t)=0 for t>(C+1.5*d),
in which C is a count of the index marker of the first type, a1 is a first linear coefficient, and a2 is a second linear coefficient. This function will try to obtain index marker insertion at fixed intervals in time of C*d, but allows an early of late insertion depending on the recording time discontinuity.

In an even further embodiment, especially suited for the ‘pre-scan’ alternative, the method further comprises a pre-scan of the data stream to obtain the recording time discontinuities in the data stream. By knowing the number of discontinuities of a data stream before starting the actual recording, it is possible to choose the number of, and the positions of the index marker insertions in a logical and efficient manner.

A subset of recording time discontinuities may be selected from all detected recording time discontinuities as starting points for a new segment, for which the value of CMIₚₛ is minimized. The parameter CMIₚₛ is given by:
CMIₚₛ=C·(1−coverage)+I·imbalance
in which

$$coverage = \frac{{\sum }_{C} {delta}_{C}}{{\sum }_{S} {delta}_{S}}$$

is a coverage property of the data recording, with

delta_{c}=difference in recording start time of recording segment c and recording end time of the previous recording segment c;

deltaₛ=difference in recording start time of data segment s and recording end time of the previous data segment s; and

$$imbalance = {\sum }_{c} \vert {dur}_{c} - avrdur \vert$$

is an imbalance property of the data recording, with

avrdur=predefined average recording segment duration;

dur_{c}=duration of recording segment c;

and

C=a predefined constant weight factor for the coverage property,

I=a predefined constant weight factor for the imbalance property.

The aim is to obtain an imbalance value as close to zero as possible, and a coverage value as close as possible to one.

In a further embodiment of the present invention, the method further comprises translation of selected index markers of the first type into index markers of a second type, called title boundaries in digital video recording based on a predetermined set of criteria. The index markers of the second type may be recorded in the table of contents (TOC) of a DVD, thus allowing to select a title boundary in order to start a playback of that part of the data recording. Changing the index marker of the first type into an index marker of the second type is a simple and efficient operation.

In a further aspect, the present invention relates to a recording system as defined in the preamble above, in which the processing means are further arranged for generating a new recording segment generated when a recording time discontinuity exceeds a threshold value, the recording time discontinuity being a difference between a recording end time of a first data segment and a recording start time of a next data segment, in which the threshold value is a function dependent on a desired recording segment duration and the present recording segment duration. The processing means may further be arranged to execute the activities of the present method. The recording system according to the present invention provides advantages associated with the advantages described above in relation to the present method.

In an even further aspect, the present invention relates to a computer program product, such as a CD-ROM or other data carrier, for obtaining a data recording on a first medium from a data stream originating from a second medium, the computer program product comprising computer executable code, which, when loaded by a computer system, provides the computer system with the functionality of the present method. A general purpose computer system, provided with suitable interfaces for receiving the data stream and for storing the data recording, can thus be transferred in a recording system.

### SHORT DESCRIPTION OF DRAWINGS

The present invention will be discussed in more detail below, using a number of exemplary embodiments, with reference to the attached drawings, in which

FIG. 1 shows a simplified diagram of a recording system according to an embodiment of the present invention;

FIG. 2 shows a diagrammatic view of a data recording provided with index markers according to an embodiment of the present invention;

FIG. 3 shows a flow diagram of two possible embodiments of the present invention;

FIG. 4 shows a plot of a threshold value function according to an embodiment of the present invention; and

FIG. 5 shows a plot of the inserted chapter markers in the data recording using associated threshold value functions.

### DETAILED DESCRIPTION OF EXEMPLARY EMBODIMENTS

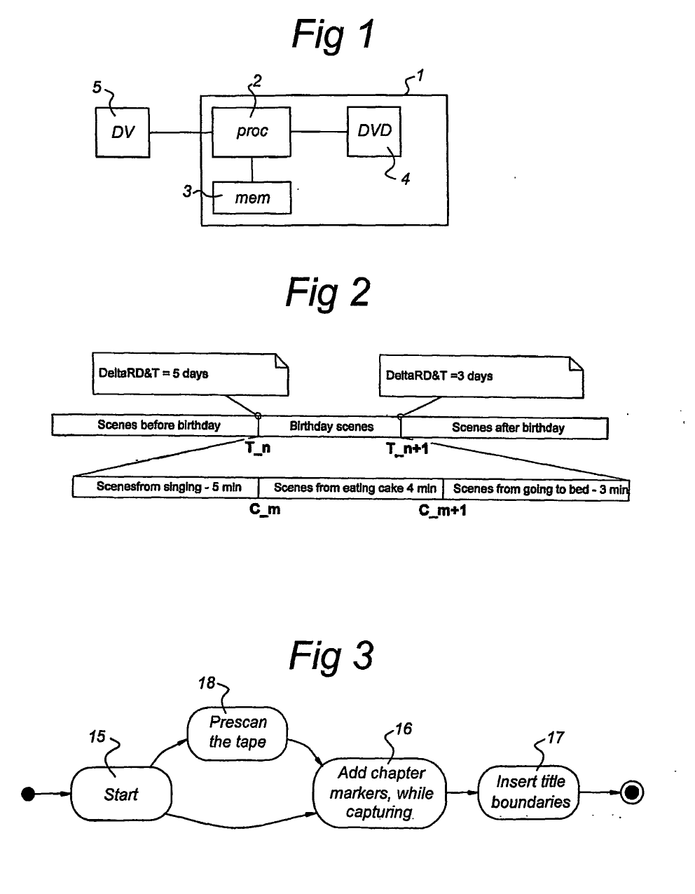

In FIG. 1, a schematic diagram is shown of a set-up of a recording system 1, e.g. a DVD recorder, comprising processing electronics 2, local memory 3 connected to the processing electronics 2, and a first recording medium 4, in this case a DVD disc. The processing electronics 2 and local memory 3 cooperate to provide the functionality of the recording system 1. The recording system 1 may be connected to a (video) data source 5, e.g. a DV camera, to record video footage from the DV camera from a second recording medium (e.g. a DV tape) to the first recording medium 4. This process is called capturing. When capturing the footage a title is created. A title is a playable entity that has an entry in a table of content (TOC) associated with the first recording medium 4. The user can access the TOC and select a title to play. The TOC may consist of key-frames, small icon pictures representing the title.

For one capturing session, one title is created. The title may be as long as the playtime of the tape 5. The drawback of this is that the video footage of the whole tape 5 is accessible as one single unit from the TOC. Usually, the video footage on the tape 5 consists of several events, recorded at different moments in time. The user may want to have direct access to the video footage belonging to these events. For this two access methods exist Through the TOC, the user can select a title (through a key-frame) and play this title directly. Within a title, the user can directly navigate to chapters. Chapters are subdivisions of titles. By pressing ‘next’ or ‘previous’ the user can continue the playback at a next title.

The present invention relates to a method for automatically dividing video footage from a camcorder 5 into titles and chapters. For this purpose, the Recording Date & Time (RD&T) of the video footage is used. The video footage consists of scenes. A scene is a piece of contiguous recording. When a recording is interrupted, a current scene is ended and a new scene is started. The start of the new scene has a later RD&T than the end of the current scene. This is called an RD&T-discontinuity, or more general, a recording time discontinuity.

A title boundary should give access to an event (for example a birthday or a day out). Usually, scenes that are recorded close in time, and that are recorded sequentially on the camcorder 5, belong to one event. A big RD&T discontinuity in between groups of scenes (for example several days) corresponds to a boundary between events. Therefore, the first order criterion for title boundaries is the size of the discontinuity. A second order criterion is that titles should be of equal length.

Within a title, navigation is through chapter markers. Chapter markers are best divided equally over time and should best be aligned at starts of scenes. Scenes with big discontinuities are preferred as they are more likely to give access to separate sub-events. First order criterion is equality of length and second order criterion is size of the discontinuity.

In FIG. 2, an example is given of a data stream 10 originating from the DV tape 5. In the figure, locations of title boundaries (T_n and T_n+1) and chapter markers (C_m and C_m+1) are indicated. DeltaRD&T indicates the size of the discontinuity between scenes.

For example: A tape 5 could contain various events of which one is a birthday. The last scene before the birthday was recorded 5 days before the birthday. All birthday scenes are recorded on the birthday, while the first scene after the birthdays is recorded 3 days later. The birthday scenes belong to Title n. Within the birthday a number of chapters are formed, based on the length of the scenes in a chapter.

In FIG. 3, a flow diagram is shown of two possible embodiments of the present method. The present method for obtaining an indexed data recording on the DVD 4 is done in two steps. First, index markers of a first type, or chapter markers, are inserted in step 16. In the following step 17, a translation is performed of selected chapter markers into title boundaries (index markers of a second type).

The reason for not immediately inserting title boundaries, but to translate selected chapter markers is twofold:
a. It allows for manual translation as opposed to automatic translation. The advantage is that the user can make the selection of which chapter markers to use.
b. Chapter markers allow fast insertion of title boundaries. In fact insertion of a title boundary is the splitting of one title into two, where the split point is the chapter marker. If a title is split at a point which is not at a chapter marker, then a time consuming operation needs to be performed.

Optionally, step 16 may be preceded by a further step 18, in which a pre-scanning of the tape 5 is performed. This has the potential advantage that all the video material is known beforehand, such that a better positioning of chapter markers can be made. Without pre-scanning, the method for adding chapter markers is called the “On-the-fly algorithm”. With pre-scanning, the method for adding chapter markers is called the “Pre-scan algorithm”.

The “On the fly algorithm” inserts chapter markers while capturing the video material. With the “On the fly algorithm”, chapter markers have to be inserted, based on knowledge of the video material up to the point of insertion. It is not know how much video material is to be recorded totally, nor is anything know about the RD&T information in the video material yet to come.

The decision to insert a chapter marker at some point is based on the following criteria:

1. The amount of chapter markers inserted so far

2. The elapsed time since the recording was started,

3. The presence and magnitude of an RD&T discontinuity

Objectives are to catch the big discontinuities and to keep the distance between chapter markers equal and close to a desired value.

These criteria are expressed in a threshold function. If an RD&T discontinuity is present and its magnitude exceeds the threshold then a chapter marker is inserted. A very simple threshold function would be a constant of for example 2 hours. Any RD&T discontinuity that exceeds two hours would cause a chapter marker to be inserted. Such a threshold function would only satisfy the third criterium above.

Assume that a number of chapter markers C has been inserted so far. Assume that d is the desired chapter duration, e.g. 15 minutes. If all chapters have the same length then every d units of time a new chapter is inserted. Ideally, the (C+1)^{th} chapter marker is placed at t=(C+1)*d.

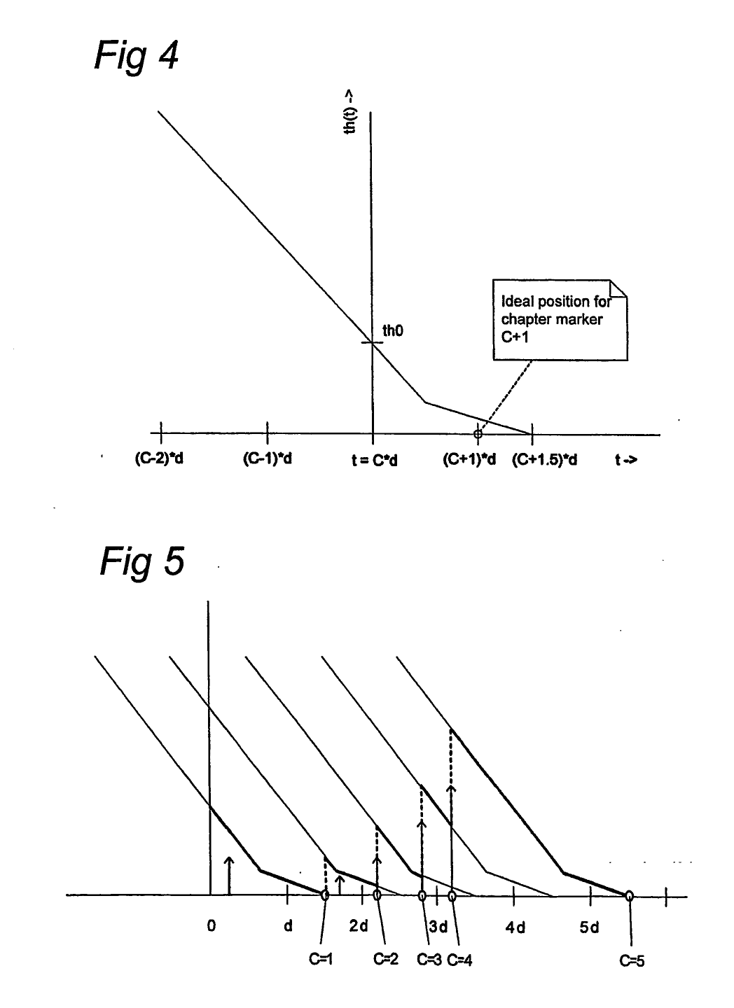

Now let the threshold function be th(t), with a shape as defined in FIG. 4. The following cases may be discerned when placing chapter marker C+1:
t<C*d 1
This is even before the position where chapter marker C would have been inserted ideally. The threshold level is high, but is decreased as t=(C+1)*d is approached.
   t>C*d and t=<(C+1)*d 2
The ideal position for chapter marker C+1 is being approached. The threshold is decreased.
   t>(C+1)*d 3
The ideal position of chapter marker C+1 has already passed. The threshold is further decreased until zero at t=(C+1.5)*d.

The threshold function in FIG. 4 may also be expressed as a combination of two linear functions using the following mathematical expressions:
th(t)=tho−a1*(t−C*d) for t<(C+0.5)*d: a first linear coefficient a1 is used;
th(t)=th1−a2*(t−(C+1)*d) for (C+0.5)*d<t<(C+1.5)*d: a second linear coefficient a2, smaller than a1 is used;
th(t)=0 for t>(C+1.5*d).

In FIG. 5, an example is shown how the chapter markers are inserted during a recording using the above described embodiment. In the plot, the threshold value th(t) over time during a recording is shown. The horizontal axis is elapsed time while recording. The vertical axis is the RD&T value. The thick line shows the actual threshold while recording is ongoing. The arrows pointing upwards from the horizontal axis are RD&T discontinuities. The circles on the horizontal axis are chapter markers.
At t_{—}1.5*d the first chapter marker is inserted. Because no discontinuity exceeded the threshold, a chapter marker is inserted when the threshold becomes 0. The new threshold function for C=1 becomes effective.
Shortly after t=2*d the second chapter marker is inserted, because an RD&T discontinuity exceeds the threshold. Chapter marker 2 is inserted. The new threshold function for C=2 becomes effective.
At t is close to 3*d another RD&T discontinuity exceeds the threshold. Chapter marker 3 is inserted. The new threshold function for C=3 becomes effective.
Shortly after t=3*d the fourth chapter marker is inserted, because an RD&T discontinuity exceeds the threshold. The new threshold function for C=4 becomes effective.
At At t_{—}5.5*d the fifth chapter marker is inserted. Because no discontinuity exceeded the threshold, a chapter marker is inserted when the threshold becomes 0.

The actual shape of the threshold function th(t) can be any shape, for example linear (as shown), quadratic, or even exponential. Experiments so far show that a linear function already gives good results.

When inserting chapter markers and title boundaries in a recording, there are certain criteria to the positioning of the chapter markers. These criteria can be described using mathematical formulations of relevant parameters.

Firstly, the chapter markers must be well distributed over elapsed time, which can be formulated using the parameter imbalance.

$$imbalance = \frac{{\sum }_{C} \vert {dur}_{C} - avrdur \vert}{totdur} \qquad ( 1 )$$

in which

totdur=total duration of video material

avrdur=predefined average chapter duration

dur_{c}=duration of chapter c

The value of imbalance should be as close as possible to 0. As the parameter totdur is a constant for a specific data recording, this parameter could be left out in formula (1).

Secondly, it is an aim to optimise the ratio of the time coverage of the original dta segments or scenes of the data stream, and the time coverage of the eventual chapters in the resulting data recording. This ratio can be described by the following formula:

$$coverage = \frac{{\sum }_{C} {delta}_{C}}{{\sum }_{S} {delta}_{S}} \qquad ( 2 )$$

with

delta_{c}=delta RD&T of chapter c

deltaₛ=delta RD&T of data segment or scene s

A delta RD&T is the difference between the RD&T of the video at the start of the scene/chapter and the RD&T of the video at the end of the previous scene/chapter. The value of coverage should be as close as possible to 1.

In FIG. 3 an alternative embodiment of the present invention is shown, including a step 18 in which the original data stream is pre-scanned in order to obtain all recording time discontinuities beforehand. Execution of the pre-scan algorithm starts by collecting of all RD&T discontinuities from captured video material. For example, if the video material is captured using DV tape, then RD&T discontinuities can be collected by fast-forwarding from the beginning up to the end of the DV tape (RD&T information is embedded in the DV stream).

The problem of chapter marker insertion (CMI, step 16), which represents the second phase of the pre-scan algorithm, can be then formulated using equations (1) and (2) in the following way. From the set of all detected RD&T discontinuities, a subset has to be selected that will minimize the equation (3).
CMIₚₛ=C·(1−coverage)+I·imbalance (3)
where:

C=a predefined constant (weight factor for coverage property)

I=a predefined constant (weight factor for imbalance property)

When a minimal value of CMIₚₛ found, all currently selected RD&T values will become chapter markers.

Formulated in such way the CMI problem belongs to the group of combinatorial optimization problems that are, again, part of more general group of non-linear optimization problems. It is well known that non-linear optimization problems can't be solved using analytical methods. So, in order to solve it, a heuristic method can be used. What is interesting about this problem is that the value of the global minimum of CMIₚₛ is known and equal to 0. This is a theoretical minimum, it is not certain that a solution exists for this minimum. The knowledge of the theoretical minimum can be very well used, while executing pre-scan algorithm, to estimate the quality of the current solution.

It was decided to use a canonical version of the genetic algorithm (GA) (see “Genetic Algorithms in Search, Optimization and Machine Learning”, D. E. Goldberg, Addison-Wesley, ISBN 0-201-15767-5) for solving the CMI problem (other, more complicated, versions of GA may be also used). In generation n (iteration n) of GA various genetic operators (selection, cross-over, mutation) are executed, sequentially, on the current GA population n in order to create new population n+1 (from generation n+1). This process iterates as long as the best solution from current population is improving. In each generation, population contains set of the coded solutions (chromosomes) of the CMI problem.

In order to execute GA operators in a proper way the following items must be defined: the way the solution of the CMI problem is coded to chromosome, the fitness function and, the genetic operators.

Each solution of the CMI problem represents the subset of all known RD&T values collected from the video material in the first phase of the pre-scan algorithm. If all RD&T values are put in one array then a simple binary string (array) can be used to address one possible RD&T subset. This is the simplest way to represent the solution of CMI problem. It is also very well suited representation for canonical version of GA.

The GA has to be able to easily compare two solutions of the CMI problem. For this purpose we can use equation (3).

The following GA operators can be used:

as selection: tournament selection,

as cross-over: one point crossover,

as mutation operator: binary mutation with the small mutation probability.

Other, more complicated, operators can also be used. Note that this proposal doesn't guarantee that the global minimum of the CMI problem will be reached.

The final phase of the present invention (step 17 in FIG. 3) can be applied to both embodiments described above. The title boundary insertion is only done after the video footage scene information is known within the system. Therefore, a pre-scan algorithm can be used. The criteria as in defined above for the imbalance and coverage parameters can be used. The difference is that chapters take the role of scenes/data segments and that titles take the role of chapters. This can be done because only chapter markers are candidates for title boundaries. Title boundary insertion at a place where no chapter marker exists, is prohibited.

1. Method for obtaining a data recording on a first medium from a data stream originating from a second medium, the data stream comprising a plurality of data segments each having a different recording start time,
the method comprising:
generating a recording segment of the data recording on the first medium based on a determination of a duration of a present recording segment,
characterized in that a new recording segment is generated when a recording time discontinuity exceeds a threshold value, the recording time discontinuity being a difference between a recording end time of a first data segment and a recording start time of a next data segment.

2. Method according to claim 1, in which the threshold value is a function dependent on a desired recording segment duration (d) and the present recording segment duration.

3. Method according to claim 1, in which the new recording segment is generated by insertion of index markers of a first type in the data recording on the first medium.

4. Method according to claim 1, in which the threshold value function is a continuously decreasing function in time.

5. Method according to claim 4, in which the threshold function comprises a combination of two linear functions in time:
th(t)=tho−a1*(t−C*d) for t<(C+0.5)*d;
th(t)=th1−a2*(t−(C+1)*d) for (C+0.5)*d<t<(C+1.5)*d;
th(t)=0 for t>(C+1.5*d),
in which C is a count of the index marker of the first type, a1 is a first linear coefficient, and a2 is a second linear coefficient.

6. Method according to claim 1, further comprising a pre-scan of the data stream to obtain the recording time discontinuities in the data stream.

7. Method according to claim 6, in which a subset of recording time discontinuities is selected from all detected recording time discontinuities as starting points for a new segment, for which the value of CMIₚₛ is minimized,
CMIₚₛ=C·(1−coverage)+I·imbalance
in which
$$coverage = \frac{{\sum }_{C} {delta}_{C}}{{\sum }_{S} {delta}_{S}}$$
is a coverage property of the data recording, with
delta_{c}=difference in recording start time of recording segment c and recording end time of the previous recording segment C;
deltaₛ=difference in recording start time of data segment s and recording end time of the previous data segment s; and
$$i mbalance = {\sum }_{c} \vert {dur}_{c} - avrdur \vert$$
is an imbalance property of the data recording, with
avrdur=predefined average recording segment duration;
dur_{c}=duration of recording segment c;
and
C=a predefined constant weight factor for the coverage property;
I=a predefined constant weight factor for the imbalance property.

8. Method according to claim 1, in which the method further comprises translation of selected index markers of the first type into index markers of a second type based on a predetermined set of criteria.

9. Recording system for obtaining a data recording on a first medium (4) from a data stream originating from a second medium (5), the data stream comprising a plurality of data segments each having a different recording start time, the recording system (1) comprising input means for receiving the data stream from the second medium (5), output means for storing the data recording on the first medium (4), and processing means (2, 3) connected to the input means and output means, which processing means are arranged for generating a recording segment of the data recording on the first medium (4) based on a determination of a duration of a present recording segment, characterized in that the processing means (2, 3) are further arranged for generating a new recording segment generated when a recording time discontinuity exceeds a threshold value, the recording time discontinuity being a difference between a recording end time of a first data segment and a recording start time of a next data segment.

10. Recording system according to claim 9, in which the threshold value is a function dependent on a desired recording segment duration (d) and the present recording segment duration.

11. Recording system according to claim 9, in which the processing means are further arranged for generating a new recording segment by insertion of index markers of a first type in the data recording on the first medium.

12. Recording system according to claim 9, wherein the threshold value function is a continuously decreasing function in time.

13. Recording system according to claim 12, wherein the threshold function comprises a combination of two linear functions in time:
th(t)=tho−a1*(t−C*d) for t<(C+0.5)*d;
th(t)=th1−a2*(t−(C+1)*d) for (C+0.5)*d<t<(C+1.5)*d;
th(t)=0 for t>(C+1.5*d),
in which C is a count of the index marker of the first type, a1 is a first linear coefficient, and a2 is a second linear coefficient.

14. Recording system according to claim 9, wherein the processing means are further arranged for pre-scanning of the data stream to obtain the recording time discontinuities in the data stream.

15. Recording system according to claim 14, wherein the processing means are further arranged for selecting a subset of recording time discontinuities from all detected recording time discontinuities as starting points for a new segment, for which the value of CMIₚₛ is minimized,
CMIₚₛ=C·(1−coverage)+I·imbalance
in which
$$coverage = \frac{{\sum }_{C} {delta}_{C}}{{\sum }_{S} {delta}_{S}}$$
is a coverage property of the data recording, with
delta_{c}=difference in recording start time of recording segment c and recording end time of the previous recording segment C;
deltaₛ=difference in recording start time of data segment s and recording end time of the previous data segment s; and
$$imbalance = {\sum }_{c} \vert {dur}_{c} - avrdur \vert$$
is an imbalance property of the data recording, with
avrdur=predefined average recording segment duration;
dur_{c}=duration of recording segment c; and
C=a predefined constant weight factor for the coverage property;
I=a predefined constant weight factor for the imbalance property.

16. Recording system according to claim 9, wherein the processing means are further arranged for translating of selected index markers of the first type into index markers of a second type based on a predetermined set of criteria.

17. Computer program product for obtaining a data recording on a first medium (4) from a data stream originating from a second medium (5), the computer program product comprising computer executable code, which, when loaded by a computer system, provides the computer system with the functionality of the method according to claim 1.
